(19) United States
(12) Patent Application Publication
(10) Pub. No.: US 2012/0104858 A1
(43) Pub. Date: May 3, 2012

(54) ELECTRONIC CIRCUIT FOR CONVERTING A MAINS-OPERATED LUMINAIRE INTO AN EMERGENCY LUMINAIRE

(75) Inventor: Michel Noe, Unterageri (CH)

(73) Assignee: POLYNOM AG, Kleindottingen (CH)

(21) Appl. No.: 13/375,657

(22) PCT Filed: May 26, 2010
(86) PCT No.: PCT/CH2010/000136

§ 371 Date: Jan. 13, 2012

(30) Foreign Application Priority Data
Jun. 5, 2009 (EP) 09405096.0

(51) Int. Cl. H02J 7/02; H02J 9/00

(52) U.S. Cl. 307/66

(57) ABSTRACT

An electronic circuit is provided for converting an existing mains-operated luminaire into an emergency luminaire. The mains-operated luminaire includes an LED array and a mains converter for supplying the same with power. An emergency lighting element having an electronic circuit supplies the LED array with power from a storage battery during emergency operation. During the transition to the emergency operation, the circuit disconnects the power supply from the mains converter and subsequently controls the power output of the storage battery and the input power of the LED array by way of a closed loop.

The invention relates to the field of electronic circuits for emergency lighting systems, and in particular to an electronic circuit for converting a mains-operated luminaire into an emergency luminaire.

### PRIOR ART

In the emergency lighting system of a building, the escape routes need to be not only indicated but also illuminated. For this reason, so-called emergency light elements are provided, by means of which normal luminaires can be reconstructed or used not only as mains-operated luminaires but also as emergency luminaires. By means of such emergency elements, the light-emitting means is isolated from the converter used in the mains operating mode in the event of a mains failure and is supplied with power via the emergency element or a voltage produced from the rechargeable battery. Such emergency elements are known for all light-emitting means (for example fluorescent tubes and halogen lamps) and are produced by a large number of manufacturers.

Nowadays, LED luminaires are increasingly installed in buildings, i.e. luminaires which use light-emitting diodes (LEDs) as the light-emitting means. At present, there is no universal emergency light element which can supply power to the light-emitting diodes intended for the mains operating mode in the luminaire in the emergency operating mode as well in order to convert or use such a luminaire as an emergency luminaire which can be used to illuminate the escape routes.

### Problem:

There are combined devices which can feed a specific LED arrangement both in the mains operating mode and in the emergency operating mode. This specific LED arrangement is seldom compatible with the LED arrangement of the LED luminaire which is used for the normal mains operating mode. This means that additional light-emitting diodes need to be installed in the LED luminaire for the emergency operating mode.

For LED luminaires which are supplied with a constant voltage, it is also possible to use a DC supply fed from a rechargeable battery in the emergency operating mode. However, in this case it is difficult to reduce the power consumed by the light-emitting diodes in the emergency operating mode. Correspondingly, the rechargeable batteries need to be overdimensioned.

WO 2006/030432 A1 describes a luminaire with an integrated battery which is fed either from the mains system (mains operating mode) or from the battery (emergency operating mode) via a converter, which is likewise integrated. The converter circuit for the mains operating mode and emergency operating mode is the same and is designed with respect to the light-emitting means used.

DE 10 2006 030 655 A1 discloses a converter circuit for an LED emergency light device. In this case too, the converter circuit is the same for the mains operating mode and the emergency operating mode and is designed with respect to the light-emitting means used.

### DESCRIPTION OF THE INVENTION

The object of the invention is therefore to provide an electronic circuit for converting an existing mains-operated luminaire into an emergency luminaire of the type mentioned at the outset and a mains-operated luminaire with such a circuit and a method for operating such a circuit which eliminate the mentioned disadvantages.

This object is achieved by an electronic circuit (“emergency light element”) for converting an existing mains-operated luminaire into an emergency luminaire having the features of patent claim 1, a mains-operated luminaire as claimed in claim 9, and a method as claimed in claim 10.

Therefore, the emergency light element comprises:
a mains connection for supplying power from an electrical mains system;
a rechargeable battery connection for connection to a rechargeable battery;
a mains converter connection for connection to an output of a mains converter of the existing mains-operated luminaire;
an LED connection for connection to an LED arrangement of the existing mains-operated luminaire; wherein the emergency light element, depending on whether a mains voltage is present or not, can be operated in a mains operating mode and an emergency operating mode, and further comprises:
a charger for charging a rechargeable battery connected to the rechargeable battery connection in the mains operating mode and for detecting a mains state,
an emergency converter,
   which is intended to operate as a flyback converter or boost converter in the emergency operating mode and in the process to convert a rechargeable battery voltage into a smoothed output voltage,
a switchover relay, by means of which the LED connection can be connected to the emergency converter in the emergency operating mode and to the mains converter connection in the mains operating mode, and
an electronic controller, which is designed to monitor the mains state, to control the switchover from the mains operating mode to the emergency operating mode and from the emergency operating mode to the mains operating mode and, for this purpose, to drive the emergency converter and the switchover relay,
   wherein the controller is designed to regulate the input power of the emergency converter, i.e. the power drawn from the rechargeable battery at the rechargeable battery connection in the emergency operating mode.

The mains-operated luminaire, in its function as a mains-operated luminaire, comprises the following elements:
a light-emitting means, which has light-emitting diodes (LEDs) connected to one another to form an LED arrangement,
a mains converter, which supplies the current and voltage suitable for this LED arrangement to this LED arrangement from a feed mains system via a mains switch in the mains operating mode.

The mains-operated luminaire, in its function as an emergency luminaire, comprises the following elements:
the LED arrangement,
the mains converter,
a rechargeable battery, from which the energy for the illumination is drawn in the emergency operating mode, i.e. in the case of a mains failure,
an emergency light element, which has an electronic circuit;
   wherein the electronic circuit comprises the following elements:
a charger, which charges the rechargeable battery in the mains operating mode and is designed to detect a mains state,
an emergency converter, which is not identical to the mains converter, and
   which is intended to operate as a flyback converter or as a boost converter in the emergency operating mode and in the process to convert the rechargeable battery voltage into a smoothed output voltage,
   wherein an output power provided by the emergency converter to the LED arrangement in the emergency operating mode is lower than the output power provided by the mains converter in the mains operating mode, and
   wherein an output voltage provided by the emergency converter is greater than the forward voltage required for the LED arrangement,
a switchover relay, by means of which the LED arrangement can be connected to the emergency converter in the emergency operating mode and to the mains converter, which is intended for the mains operating mode, in the mains operating mode, and
an electronic controller, which is designed to monitor the mains state, to control the switchover from the mains operating mode to the emergency operating mode and from the emergency operating mode to the mains operating mode and, for this purpose, to drive the emergency converter and the switchover relay,
   wherein the controller is designed to regulate the input power of the emergency converter, i.e. the power drawn from the rechargeable battery, in the emergency operating mode, and therefore enables the use of the emergency light element in different mains-operated luminaires comprising light-emitting diodes.

The invention makes it possible to construct a universal device as an emergency light element which can be used to convert each LED luminaire into an emergency luminaire. The emergency light element can therefore be produced as a universal, independent device and can be installed as an additional device in an existing LED luminaire. In this case, it is connected to the existing mains-operated luminaire via at least the mains converter connection and the LED connection. The invention uses tried and tested technologies, namely relay contacts, in order to isolate connections and a flyback converter or boost converter for supplying power to the LED arrangement above a rechargeable battery voltage. This flyback converter or boost converter regulates the power drawn from the rechargeable battery and correspondingly enables use for virtually any LED arrangement.

The universal usability of the circuit is a result of the combination of the various features of the invention: inter alia, the switchover relay enables the use of the mains converter of an already existing luminaire for normal operation; although the power regulation of the emergency converter is more complex than in the case of a circuit which could be used for a light-emitting diode arrangement with known parameters, it does make it possible to use the circuit with virtually any desired light-emitting diode arrangements.

Further preferred embodiments are given in the dependent patent claims.

### BRIEF DESCRIPTION OF THE DRAWINGS

The subject matter of the invention will be explained in more detail below with reference to preferred exemplary embodiments, which are illustrated in the attached drawings, in which, in each case schematically:

FIG. 1 shows a preferred embodiment of an electronic circuit for converting a mains-operated luminaire into an emergency luminaire;

FIG. 2 shows details of the converter used therein.

In principle, identical parts have been provided with the same reference symbols in the figures.

### APPROACHES FOR IMPLEMENTING THE INVENTION

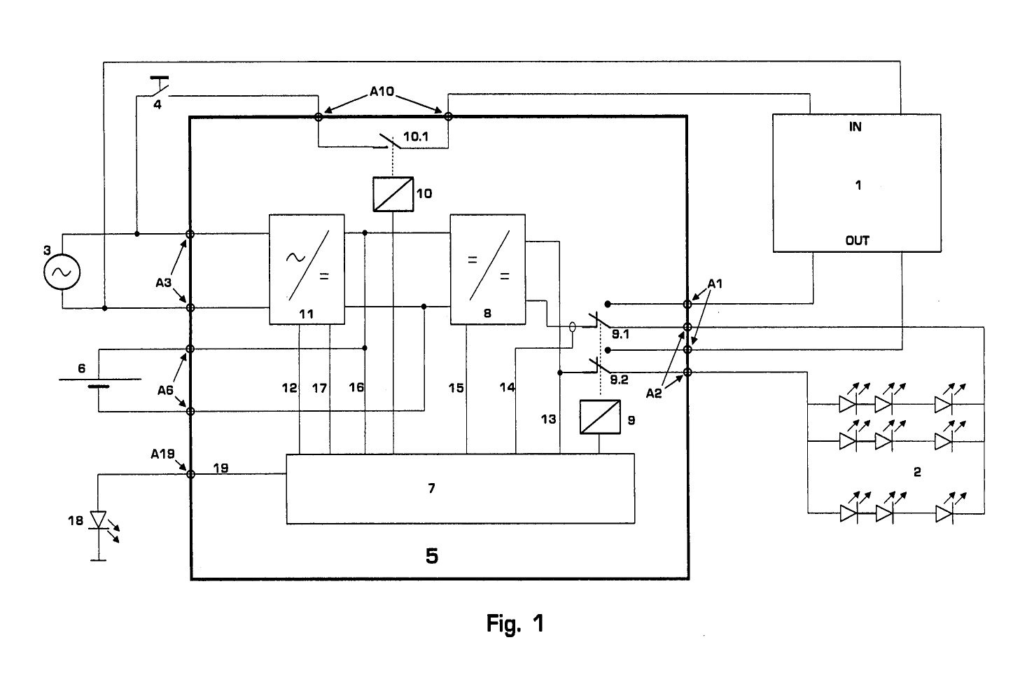

FIG. 1 illustrates a possible embodiment of the invention: an LED luminaire in accordance with the prior art has a converter, referred to below as mains converter 1, and one or more light-emitting diodes 2 installed in an LED arrangement. The LED luminaire is switched on and off from the mains voltage 3 via a switch 4. According to the invention, there is an emergency light element 5 with an emergency converter 8, which can be installed in the luminaire together with a rechargeable battery 6 in order to use the luminaire as an emergency luminaire. By means of the emergency light element 5, virtually any LED luminaire or any LED arrangement 2 can be fed in the emergency operating mode, independently of the converter 1, which is intended for the mains operating mode. The only limitation consists in the voltage of the LED arrangement, as will be explained below in the detailed description of the emergency converter 8.

### Description of the Emergency Light Element 5:

The emergency light element 5 is intended
to be connected to a mains system 3 at a mains connection A3;
to be connected to a rechargeable battery 6 at a rechargeable battery connection A6;
to be connected to the output of a mains converter 1 at a mains converter connection A1;
to be connected to an LED arrangement 2 for the purpose of feeding said LED arrangement at an LED connection A2;
to be connected to a mains system 3 at a mains connection A3;
to be connected into at least one branch of the input (for feeding) of the mains converter 1 at an isolating connection A10;
(optional) to drive one LED 18 or another indicator means at a signal connection A19.

The various connections are generally two-pole in each case.

The emergency light element 5 has the following components:

Charger 11: This charger is a conventional charger which charges the rechargeable battery 6 after a mains failure from the mains system 3 again. Preferably, this charger 11 is in the form of a switched-mode power supply in order to reduce the dimensions and increase the efficiency. For such low powers as in the case of rechargeable battery charging, flyback converters or boost converters are the most suitable. The mains system 3 is also monitored by means of the charger 11. A signal 12 is generated which simulates the mains state. The signal is preferably a monotonically rising function of the mains voltage, for example proportional to the mains voltage or to the square or square root of the mains voltage.

Emergency converter 8: This converter operates as a flyback converter or boost converter. In the case of a mains failure, the rechargeable battery voltage is converted by this emergency converter 8 into an output voltage 13 which is suitable for the LED arrangement 2 and which is equal to the LED voltage across the LED arrangement 2. The detailed description of this converter is given below.

Switchover relay 9: The LED arrangement is connected to the mains converter 1 in the mains operating mode or to the emergency converter 8 in the emergency operating mode by means of this relay. Preferably, it implements two-pole switchover, i.e. there are two changeover switches, one each for the positive and negative connections of the LED arrangement 2.

Isolating relay 10: The mains converter 1 of the LED luminaire can be switched on or off by means of this relay. In the emergency operating mode when the LED arrangement 2 is supplied with power from the rechargeable battery by the emergency converter 8, the mains converter 1 is isolated from the mains system by the isolating relay 10. This prevents the mains converter 1 from attempting to supply power to the LED arrangement 2 once the mains is restored. In this case, this LED arrangement 2 is possibly still isolated from the mains converter 1 by the relay contacts of the switchover relay 9.

The use of the isolating relay 10 ensures that, once the mains has been restored, the LED arrangement 2 is first isolated from the emergency converter 8 or connected to the mains converter 1 and only then is power supplied to the mains converter 1 again from the mains system 3.

The use of the isolating relay 10 also ensures that, in the event of a mains failure, the mains converter 1 is first isolated from the mains system 3 and only then is the LED arrangement 2 connected to the emergency converter 8. This prevents the LED arrangement 2 from being supplied with power shortly before, shortly after or during the switchover of the switchover relay 9 by the mains converter 1 and emergency converter 8.

In principle, it is also possible for a relay or a control line for transmitting a signal for switching off the mains converter 1 to be provided instead of the isolating relay if the mains converter 1 has a control input by means of which it can be switched off.

Controller 7: This electronic controller is preferably implemented by a microcontroller or by a microprocessor or an ASIC etc. The following tasks are preferably performed by this microcontroller:
Mains monitoring: The signal 12 which simulates the mains system is measured by the microcontroller 7 and compared with a minimum value. If the signal falls below this value, the mains system is identified as being faulty and the emergency operating mode is correspondingly activated.
Control of the switchover relay 9 and the isolating relay 10: Switchover from the mains operating mode to the emergency operating mode first takes place by the isolating relay 10 being disconnected. As a result, the mains converter 1 becomes deenergized on the input side. Then it is necessary to provide a time delay since the mains converter 1 can supply power to the LED arrangement 2 for a while even without the mains system by means of its own internal capacitance.
This time delay is typically 200 ms. After this time delay has elapsed, the switchover relay 9 is switched over by the controller 7. Then, the LED arrangement can be supplied with power by the emergency converter 8.
The switchover from the emergency operating mode to the mains operating mode takes place with the reverse sequence. That is to say that, once it has been disconnected by the emergency converter 8 and after a specific time delay, the switchover relay 9 is switched over, and only then is the isolating relay 10 switched on. A time delay, typically 20 ms, between these two switching operations needs to be provided in addition because the relay contacts can bounce after the relay control.
Monitoring of the LED arrangement 2: In the case of the LED arrangement 2, the LED voltage 13 at a voltage divider 27 of the LED voltage and the LED current 14 are preferably monitored by the microcontroller in order to determine the state of the LED arrangement and to protect the emergency converter 8. Since this converter operates as a current source, the LED voltage 13 could rise to an unlimited extent, or at least up to dangerous values, if the LED arrangement 2 is faulty or is not connected. The limitation of the LED voltage 13 can be implemented by the controller 7 or by a protective circuit in the emergency converter 8.
Control of the emergency converter 8: Since the emergency converter 8 operates as a flyback converter or as a boost converter, it is possible to implement the control required for this purpose by means of the microcontroller 7: the transistor of the emergency converter 8 is controlled by a PWM signal 15 (pulse-width-modulated signal) generated internally in the microcontroller 7.
Monitoring of the rechargeable battery 6: The rechargeable battery voltage 16 is measured or monitored by the microcontroller 7. With the monitoring, a check is made to ascertain whether the rechargeable battery 6 is being charged correctly in the mains operating mode. In the emergency operating mode, i.e. when the rechargeable battery 6 is discharging, said rechargeable battery is protected from exhaustive discharge. That is to say that the emergency operating mode is interrupted below a certain rechargeable battery voltage, for example 0.9 V per cell in the case of NiCd cells, and the current drawn from the rechargeable battery 6 is reduced to a minimum value.
Preferably, owing to the measurement of the rechargeable battery voltage, the emergency converter 8 is controlled in the emergency operating mode. That is to say that the output current of the emergency converter 8 is regulated depending on the rechargeable battery voltage 16. It is also possible to control the charging method of the rechargeable battery 6 by means of this rechargeable battery voltage measurement. This takes place via a signal 17, corresponding to the rechargeable battery voltage which can be detected by a voltage divider 34 and can control the charger 11, for example for matching of the charge voltage and/or charge current.
Emergency light element state indicator 18: The interface to a user is also controlled by the microcontroller 7. FIG. 1 illustrates a sketch of a single LED 18, which is supplied with power via the signal 19. It is naturally possible to control other optical indicators or audible warnings using the microcontroller 7 or to transmit information relating to the state of the emergency element, for example via communication bus links.

### Detailed Description of the Emergency Converter 8:

### Technology of the Emergency Converter 8

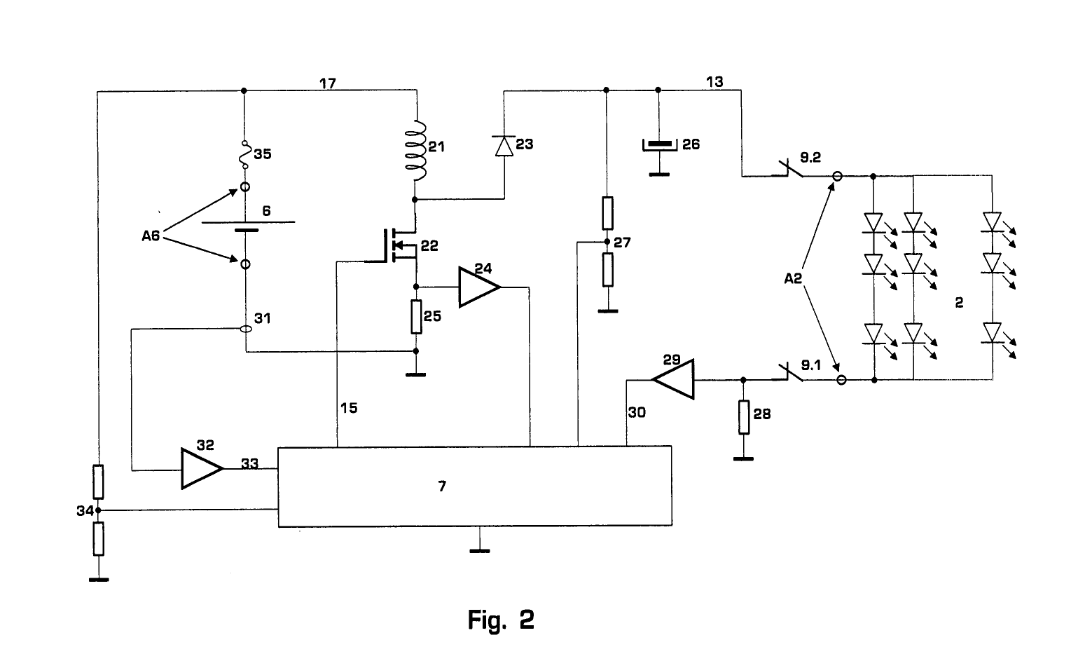

FIG. 2 illustrates an exemplary circuit for the emergency converter 8. This converter operates as a boost converter. This technology has long been known. The converter primarily comprises the following components: a transistor 22, for example a MOSFET transistor or a bipolar transistor, an inductance 21, a diode 23 and a capacitor 26. Transistor 22 is switched on or off by the control signal 15 generated from the microcontroller 7. This control signal 15 is generally in the form of a PWM signal 15 (pulse-width-modulated signal) since such signals can be generated by most microcontrollers. When the transistor 22 is switched on, the current flows out of the rechargeable battery 6 into the inductance 21 through the transistor 22. When the transistor 22 is switched off, the current flows out of the rechargeable battery 6 through the inductance 21, which then operates as a generator, and through the diode 23 into the capacitor 26 in order to generate the output voltage 13. Since the LED arrangement 2 is constructed with LEDs, the current flows into this LED arrangement 2 only when the output voltage 13 is higher than the forward voltage of the LED arrangement 2. The output current of the emergency converter 8 then flows into the LED arrangement 2 and into the resistor 28, which acts as a shunt, and by means of which this current, if necessary via an amplifier 29, can be measured as a current signal 30 from the microcontroller 7. There are also other possibilities, such as Hall effect sensors etc., for measuring this current.

### Control of the Emergency Converter 8:

The output power of the emergency converter 8 which is provided to the LED arrangement 2 is calculated as the product of the output current and the output voltage 13. The input power of the emergency converter 8 which is provided by the rechargeable battery 6 is calculated as the product of the rechargeable battery current and the rechargeable battery voltage 17.

During the control of the emergency converter 8, this input power is regulated. Regulation is understood to mean in particular controlling to a predetermined value (in contrast to merely a limitation, for example). The following strategies are possible for this:
In the first preferred variant, the output power is calculated by the microcontroller 7 via the measurement of the output voltage 13 performed by the resistor bridge 27 and via the measurement of the current signal 30, corresponding to the output current. As a result, the input power can be calculated since the two powers differ from one another only by the efficiency of the emergency converter 8. This efficiency is naturally dependent on the output power, the output voltage 13 (since the voltage drop in the diode 23 is constant and thus has more influence at lower output voltages 13) and on the temperature. Since all of the influences are or can be measured by the microcontroller 7, the efficiency of the emergency converter 8 can be calculated and open-loop-controlled or regulated.
In this variant, the PWM signal 15 is started via a ramp, i.e. so as to rise slowly. The output voltage 13 rises continuously until the current can flow into the LED arrangement 2. As soon as this current is flowing, it is measured by the microcontroller 7 and the output power can be calculated. As a result, the input power regulation can take place by virtue of digital regulation, with or without the efficiency of the emergency converter 8 being taken into consideration.
In a second preferred variant, the input power is calculated by the microcontroller 7 via the measurement of the rechargeable battery voltage 17 performed by the resistor bridge 34 and via a measurement 33 of the rechargeable battery current performed by a Hall effect sensor 31 and an amplifier 32. The current drawn from the rechargeable battery 6 in the emergency operating mode can also be transmitted to the microcontroller 7 via a shunt resistor or another measurement technology, for example drain voltage measurement in the switched-on state of a MOSFET transistor.
In this variant, too, the PWM signal 15 is started via a ramp, i.e. so as to rise slowly. The output voltage 13 rises continuously until the current can flow into the LED arrangement 2. As soon as this current is flowing, the rechargeable battery current or the input power of the emergency converter 8 rises. The input power regulation can then be performed via digital regulation.
In a third preferred variant of the controller, all current measurements are dispensed with. In this variant, the converter is only controlled in the so-called discontinuous mode. That is to say that the maximum value for the PWM signal or the maximum energy stored in the inductance with each clock is limited depending on the two rechargeable battery 17 and output voltages 13, with the result that the current falls at least approximately and ideally right down to zero after discharge of the inductance 21 into the capacitor 26 or into the LED arrangement 2 with each clock. If the transistor 22 is switched on, the current flows from the rechargeable battery into the inductance 21 (with the value L). Since the microcontroller 7 controls the switch-on duration (Tₒₙ) of the transistor 22, it is possible for said microcontroller to calculate the maximum value (Iₘₐₓ) of the rechargeable battery current using the rechargeable battery voltage 17 (U_{bat}), because this current rises continuously as a ramp, as long as the inductance 21 is not saturated: therefore the following applies: Iₘₐₓ=U_{bat}·Tₒₙ/L. For this reason, the mean value of the current, during this switch-on duration, is equal to half the maximum value Iₘₐₓ. As soon as the transistor 22 is disconnected, the current flows out of the rechargeable battery through the inductance 21 and the diode 23 into the capacitor 26 and into the LED arrangement 2. Since this current falls continuously as a ramp, it is possible for the microcontroller 7 to calculate the duration (T_{ab}) of this ramp on the basis of the maximum value (Iₘₐₓ) of the rechargeable battery current and the rechargeable battery voltage (U_{bat}) 17 and the output voltage (Uₒᵤₜ) 13. The following therefore applies: T_{ab}=L·Iₘₐₓ/(Uₒᵤₜ−U_{bat}). It is assumed here that the forward voltage of the diode 23 is negligible. Using the calculated values Iₘₐₓ and T_{ab}, it is possible for the microcontroller 7 to calculate the mean value (Iₘₑₐₙ) of the rechargeable battery current because the microcontroller 7 controls the clock frequency or the period (T) thereof. This gives: Iₘₑₐₙ=(Iₘₐₓ/2)·((Tₒₙ+T_{ab})/T). The power drawn from the rechargeable battery, which is referred to as the input power of the converter 8, can thus be calculated as Iₘₑₐₙ·U_{bat}.
Only the output voltage 13 and the rechargeable battery voltage 17 are measured by means of the resistor bridge 27 or 34 by the microcontroller 7. In this microcontroller, a table with PWM values is programmed. Since the input power can be calculated by these measurements, it is possible to program such a table in advance or when the converter is tested, for example when it is first brought into operation, into the microcontroller 7. Using the measurements of the two output 13 and rechargeable battery voltages 17, the PWM value required for the control is looked up in the table of the microcontroller 7 during operation and used for the input power regulation.
In this variant, too, the PWM signal 15 is started via a ramp up to a very low value or is set immediately to this minimum value. Since the inductance 21 in the switched-off state of the transistor 22 acts as a current source, the output voltage 13 rises until the current can flow into the LED arrangement 2, even in the case of a very low PWM value. The output voltage is then measured. Using this first measurement or the rechargeable battery voltage measurement, a first PWM value can be looked up in the table of the microcontroller 7 and used for the input power regulation. The final value required for the input power regulation is looked up and used stepwise.
Such simple regulation is known as “look ahead regulation”. The advantages of such regulation are as follows:
   The microcontroller 7 needs to perform very few calculations since all of the calculations are performed in advance.
   The only measurements required are voltage measurements which can be implemented very easily.

### Protection and Limitation of the Emergency Converter 8:

By way of protection for the transistor 22, it is possible to measure the transistor current via a shunt resistor 25, and possibly an amplifier 24. As soon as this current has exceeded a maximum value, the transistor 22 is switched off by the microcontroller 7, or better still by a circuit which is independent of the microcontroller. The current can also be transmitted via the drain voltage measurement in the switched-on state of a MOSFET transistor. With such a measurement, “desaturation monitoring” of the transistor is implemented in a manner which is known, in principle.

It is naturally possible to dispense with such a protective circuit. In this case, it is preferred to install a fuse 35 in the rechargeable battery circuit.

As further protection for the transistor 22 or for the diode 23 and the capacitor 26, the output voltage 13 which is dependent on the LED arrangement 2 is preferably monitored for the three following reasons:
1 The converter is designed for a specific maximum output voltage, typically 50 V. If the forward voltage of the LED arrangement 2 is higher than this maximum output voltage, the emergency converter 8 or the emergency light element 5 is not suitable for the intended conversion of the LED luminaire as emergency luminaire.
2 If the LED arrangement 2 is faulty or is not connected, the output voltage 13 could theoretically rise to an unlimited extent since the inductance 21 functions as a current source in the switched-off state of the transistor 22.
3 If the output power provided in the mains operating mode for the LED arrangement 2 is lower than the input power provided in the emergency operating mode, the output voltage 13 will also rise. In this case, too, the emergency converter 8 or the emergency light element 5 is unsuitable as an emergency luminaire for the intended conversion of the LED luminaire.

The monitoring of the output voltage 13 can be implemented by the microcontroller 7 itself or by a circuit which is independent of the microcontroller.

The specific LED arrangements which are described in reasons 1 and 3 mentioned above are also the borderline cases in which the emergency converter 8 or the emergency light element 5 is unsuitable as an emergency luminaire for the intended conversion of the LED luminaire.

The rechargeable battery 6 is selected in such a way that its voltage 16 is lower than the forward voltage of the LED arrangement 2. In any case, a current flows directly from the rechargeable battery 6 through the inductance 21 and the diode 23 into the LED arrangement 2 without there being the possibility of the power being regulated.

1. An emergency light element with an electronic circuit for converting an existing mains-operated luminaire into an emergency luminaire, the emergency light element comprising:
a mains connection for supplying power from an electrical mains system;
a rechargeable battery connection for connection to a rechargeable battery;
a mains converter connection for connection to an output of a mains converter of the existing mains-operated luminaire; and
an LED connection for connection to an LED arrangement of the existing mains-operated luminaire;
wherein the emergency light element, depending on whether a mains voltage is present or not, can be operated in a mains operating mode and an emergency operating mode, and further comprises:
a charger for charging a rechargeable battery connected to the rechargeable battery connection in the mains operating mode and for detecting a mains state,
an emergency converter,
which is configured to operate as a flyback converter or boost converter in the emergency operating mode and in the process to convert a rechargeable battery voltage into a smoothed output voltage,
a switchover relay, by means of which the LED connection can be connected to the emergency converter in the emergency operating mode and can be connected to the mains converter connection for connection to the output of the mains converter of the existing mains-operated luminaire in the mains operating mode, and
an electronic controller, which is designed to monitor the mains state, to control the switchover from the mains operating mode to the emergency operating mode and from the emergency operating mode to the mains operating mode and, for this purpose, to drive the emergency converter and the switchover relay, wherein the controller is designed to regulate the input power of the emergency converter, which is the power drawn from the rechargeable battery at the rechargeable battery connection in the emergency operating mode.

2. The emergency light element as claimed in claim 1, wherein the controller is designed to regulate, in the emergency operating mode during the input power regulation of the emergency converter, which is performed in the emergency operating mode, the current flowing out of the rechargeable battery at the rechargeable battery connection and not to take into consideration changes in the rechargeable battery voltage occurring at the rechargeable battery connection.

3. The emergency light element as claimed in claim 1, wherein the switchover relay for switching over the LED arrangement implements two-pole switchover and therefore ensures complete isolation of the mains converter connection and the emergency converter.

4. The emergency light element as claimed in claim 1, having an isolating connection to an isolating relay of the emergency light element, or a control output for driving the mains converter, the controller being designed to isolate, during switchover from the mains operating mode to the emergency operating mode and from the emergency operating mode to the mains operating mode, the mains converter by means of the isolating relay from the mains system at least in single-pole fashion or to switch off said mains converter by means of the control output, and thereby ensuring the switching of the switchover relay in the currentless state.

5. The emergency light element as claimed in claim 1, wherein the controller is designed to regulate, during the input power regulation of the emergency converter, which is performed in the emergency operating mode, the input power in accordance with a measurement of the rechargeable battery current and a measurement of the rechargeable battery voltage at the rechargeable battery connection, or the product thereof.

6. The emergency light element as claimed in claim 1, wherein the controller is designed to regulate, during the input power regulation of the emergency converter, which is performed in the emergency operating mode, the input power in accordance with a measurement of the output power of the emergency converter, in accordance with a measurement of the current flowing through the LED connection into the LED arrangement and a measurement of the voltage produced at the LED connection across the LED arrangement, or the product of the results of these measurements.

7. The emergency light element as claimed in claim 1, wherein the controller is designed to operate in the so-called “discontinuous mode” and to regulate, during the input power regulation of the emergency converter, which is performed in the emergency operating mode, the input power in accordance with a measurement of the rechargeable battery voltage at the rechargeable battery connection and the voltage produced at the LED connection across the LED arrangement, by means of a calculation combining the results of these two measurements.

8. The emergency light element as claimed in claim 7, wherein the controller is designed to preprogram calculation results which combine the measurements of the rechargeable battery voltage at the rechargeable battery connection and the voltage produced at the LED connection across the LED arrangement in a microcontroller, to store said calculation results as tabulated values or in look-up tables in the microcontroller memory.

9. A mains-operated luminaire with an electronic circuit for converting the mains-operated luminaire into an emergency luminaire, wherein the mains-operated luminaire comprises the following elements:
a light-emitting means, which has light-emitting diodes (LEDs) connected to one another to form an LED arrangement, and
a mains converter, which supplies the current and voltage suitable for this LED arrangement to this LED arrangement from a feed mains system via a mains switch in the mains operating mode,
wherein the mains-operated luminaire comprises the following elements in its function as an emergency luminaire:
the LED arrangement,
the mains converter,
a rechargeable battery, from which the energy for the illumination is drawn in the emergency operating mode, which is in the case of a mains failure,
an emergency light element, which comprises an electronic circuit;
wherein the electronic circuit comprises the following elements:
a charger, which charges the rechargeable battery in the mains operating mode and is designed to detect a mains state,
an emergency converter, which is not identical to the mains converter, and
which is intended to operate as a flyback converter or as a boost converter in the emergency operating mode and in the process to convert the rechargeable battery voltage into a smoothed output voltage,
wherein an output power provided by the emergency converter to the LED arrangement in the emergency operating mode is lower than the output power provided by the mains converter in the mains operating mode, and
wherein an output voltage provided by the emergency converter is greater than the forward voltage required for the LED arrangement,
a switchover relay, by means of which the LED arrangement can be connected to the emergency converter in the emergency operating mode and to the mains converter, which is intended for the mains operating mode, in the mains operating mode, and
an electronic controller, which is designed to monitor the mains state, to control the switchover from the mains operating mode to the emergency operating mode and from the emergency operating mode to the mains operating mode and, for this purpose, to drive the emergency converter and the switchover relay, wherein the controller is designed to regulate, in the emergency operating mode, the input power of the emergency converter, which is the power drawn from the rechargeable battery.

10. A method for controlling an electronic circuit in an emergency light element, comprising, in the emergency operating mode, the following step:
regulating the power drawn from a rechargeable battery.

11. A method for converting an existing mains-operated luminaire into an emergency luminaire, comprising the following steps:
providing an emergency light element as claimed in claim 1;
installing the emergency light element in the existing mains-operated luminaire at least by connecting the mains converter of the existing mains-operated luminaire to the mains converter connection and connecting the LED arrangement of the existing mains-operated luminaire to the LED connection.
